(19) United States
(12) Patent Application Publication
(10) Pub. No.: US 2016/0288462 A1
(43) Pub. Date: Oct. 6, 2016

(54) TOUCH DEVICE HAVING FLEXIBLE COMPOSITE LAYER

(71) Applicant: Coretronic Corporation, Hsin-Chu (TW)

(72) Inventors: Nan-Jiun Yin, Hsin-Chu (TW); Kun-Rong Chang, Hsin-Chu (TW); Pen-Ning Kuo, Hsin-Chu (TW)

(21) Appl. No.: 14/860,727

(22) Filed: Sep. 22, 2015

(30) Foreign Application Priority Data
Mar. 31, 2015 (TW) 104110497

(51) Int. Cl. B32B 27/06; G06F 3/042; G06F 3/041; G06F 3/044; G06F 3/0488

(52) U.S. Cl. CPC B32B 27/06; G06F 3/044; G06F 3/0488; G06F 3/0416; G06F 3/0425; B32B 2457/208; B32B 2307/416; B32B 2307/206; G06F 2203/04808

(57) ABSTRACT

A touch device includes a flexible capacitive touch film and a flexible composite layer. The flexible composite layer is disposed at the flexible capacitive touch film. A material of the flexible composite layer includes one of a magnetizable material and a magnetic material. The flexible composite layer is adapted to attract an object via a magnetic attraction force generated between the flexible composite layer and the object so that the object is capable of being attached on the flexible capacitive touch film.

### CROSS-REFERENCE TO RELATED APPLICATION

This application claims the priority benefit of Taiwan application serial no. 104110497, filed on Mar. 31, 2015. The entirety of the above-mentioned patent application is hereby incorporated by reference herein and made a part of this specification.

### BACKGROUND OF THE INVENTION

1. Field of the Invention

The invention generally relates to a touch device, and more particularly, to a touch device having a flexible composite layer.

2. Description of Related Art

As electronic devices being developed to have multiple functionalities, traditional key-type operation interfaces have gradually become unable to meet the needs of a user. Under these circumstances, touch technology has been developing vigorously. Compared with traditional key-type operation interfaces, the touch operation interfaces are simple and intuitive. The user may perform touch input on a display of the electronic device directly using a finger or a stylus. The touch technology, in addition to being implemented on a display screen of an electronic device, can also be implemented on a projection screen of a projection device (e.g. a projector), so that a user is able to perform touch input on the projection screen.

Capacitive touch technology is one of technologies for current touch operation interface, in which a touch layer is generally constituted by a substrate and indium tin oxide (ITO) electrodes on the substrate, and touch signals are generated by capacitance sensed between the electrodes and the finger of the user or other conductive material. A traditional non-touch whiteboard or blackboard generally is configured with a magnetizable metal layer so as to use a magnet to fix paper or other teaching appliance on the whiteboard or blackboard. However, if the touch projection screen is additionally be configured with the metal layer for attracting the magnet, conductivity of the metal layer may cause the touch projection screen to generate unexpected touch signals or excessive capacitance may be generated between the electrodes and the metal layer, and would interfere with a normal operation of the touch projection screen.

The information disclosed in the “BACKGROUND OF THE INVENTION” section is only for enhancement of understanding of the background of the described technology, and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention was acknowledged by a person of ordinary skill in the art.

### SUMMARY OF THE INVENTION

The invention is directed to a touch device, which is capable of attracting an object with a magnetic attraction force without affecting touch operations thereof.

Other objectives and advantages of the invention may be further understood from the technical features disclosed in the invention.

To achieve one, a part, all of the above objectives or other objectives, a touch device is provided in an embodiment of the invention. The touch device includes a flexible capacitive touch film and a flexible composite layer. The flexible composite layer is disposed at the flexible capacitive touch film. A material of the flexible composite layer includes one of a magnetizable material and a magnetic material. The flexible composite layer is adapted to attract an object via a magnetic attraction force generated between the flexible composite layer and the object so that the object is capable of being attached on the flexible capacitive touch film.

In one embodiment of the invention, the material of the flexible composite layer includes the magnetizable material and plastic.

In one embodiment of the invention, the material of the flexible composite layer includes the magnetic material and plastic.

In one embodiment of the invention, the flexible composite layer is an insulating layer.

In one embodiment of the invention, the touch device is a touch projection screen and further includes a reflective layer, which is adapted to receive an image beam projected by a projection device and reflect the image beam. The flexible capacitive touch film is disposed between the reflective layer and the flexible composite layer.

In one embodiment of the invention, the touch device is adapted to be disposed on a fixing surface, the flexible capacitive touch film has a back surface, the back surface faces towards the fixing surface, and the flexible composite layer is disposed at the back surface.

In one embodiment of the invention, the flexible capacitive touch film includes a first touch-sensing layer and a second touch-sensing layer, and the flexible composite layer is disposed between the first touch-sensing layer and the second touch-sensing layer.

In one embodiment of the invention, the touch device is adapted to be disposed on a fixing surface via a magnetic attraction force generated between the flexible composite layer and the fixing surface, and a material of a fixing surface includes a magnetizable material.

In one embodiment of the invention, the touch device is a touch projection screen and further includes a reflective layer adapted to receive an image beam projected by a projection device and reflect the image beam. The flexible composite layer is disposed between the first touch-sensing layer and the reflective layer.

The embodiments of the invention may have one of the following benefits. In the embodiments of the invention, the flexible composite layer is disposed at the flexible capacitive touch film of the touch device. The material of the flexible composite layer is the magnetizable material or the magnetic material, so that the object can be attracted on the flexible capacitive touch film with the magnetic attraction force between the flexible composite layer and the object, enabling users to use the touch device more flexibly. Since the touch device in the embodiments of the invention uses the flexible composite layer to generate the magnetic attraction force instead of using a metal layer to generate the magnetic attraction force, touch operations of the touch device are prevented from being interfered by the conductivity of the metal layer used in the conventional device, and thus the touch device could attract the object with the magnetic attraction force under a condition of not interfering the touch operations of the touch device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a touch device according to an embodiment of the invention.

FIG. 2 illustrates the touch device of FIG. 1 being installed at a curve surface.

FIG. 3 is a partial enlarged view of the touch device of FIG. 1.

FIG. 4 is a partial enlarged view of a touch device according to another embodiment of the invention.

FIG. 5 a schematic view illustrating a touch device receiving an image beam projected by a projection device according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

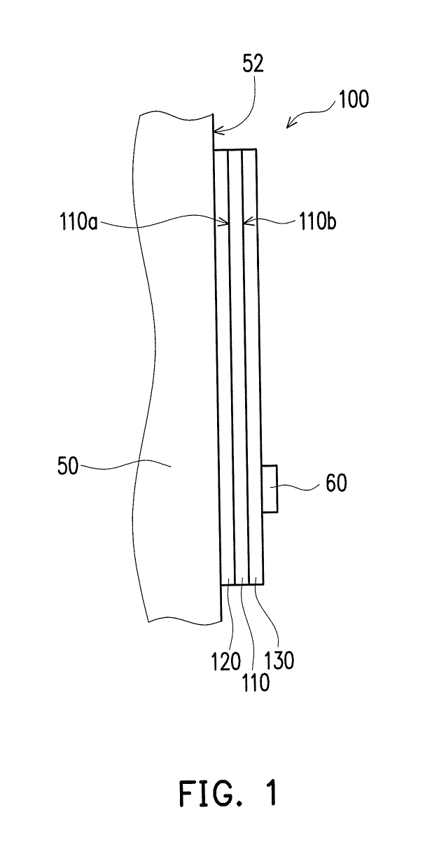

FIG. 1 is a side view of a touch device according to an embodiment of the invention. Referring to FIG. 1, the touch device 100 of the embodiment is, for example, a touch projection screen and is adapted to be disposed on a fixing surface 50. The fixing surface 50 is, for example, a wall surface or other suitable surface (e.g. an electronic whiteboard) to support or fix the touch device 100. The touch device 100 may be attached or adhered to the fixing surface 150. The touch device 100 includes a flexible capacitive touch film 110, a flexible composite (i.e. composite material) layer 120 and a reflective layer 130. The flexible capacitive touch film 110 is, for example, a projected capacitive touch film.

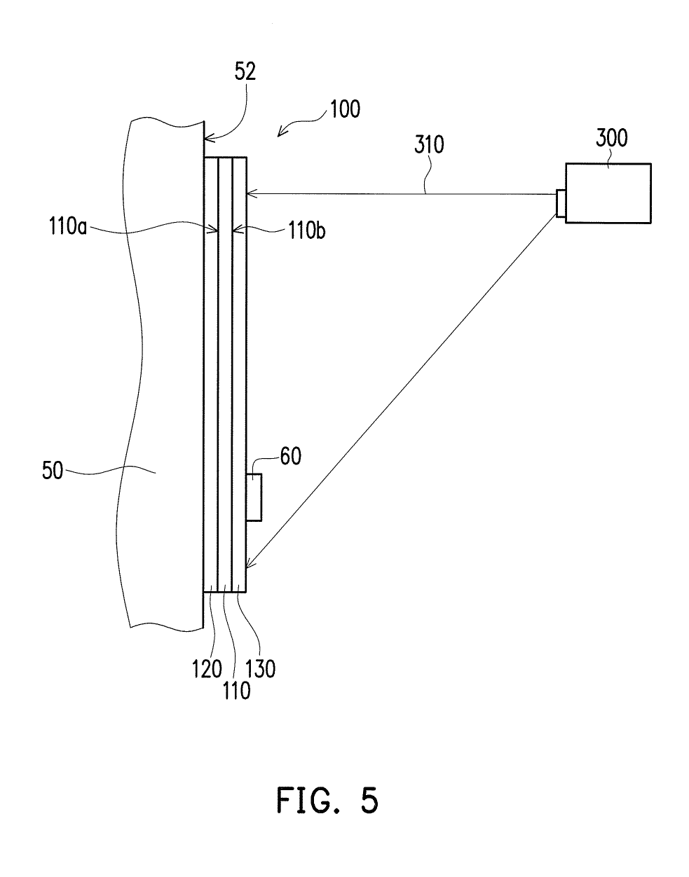

The flexible capacitive touch film 110 has a back surface 110a and a touch operation surface 110b opposite to each other. The back surface 110a faces towards the fixing surface 50, and the flexible composite layer 120 is disposed at the back surface 110a. The reflective layer 130 is disposed at the touch operation surface 110b. In other words, the flexible capacitive touch film 110 is disposed between the reflective layer 130 and the flexible composite layer 120. As show in FIG. 5, the reflective layer 130 of the touch device 100 is adapted to receive an image beam 310 projected by a projection device 300 and reflect the image beam 310, for a user to view. As such, the user may simultaneously perform a touch operation to an image projected on the projection screen.

Referring to FIG. 1, a material of the flexible composite layer 120 is, for example, a magnetizable material mixed with plastic or a magnetic material mixed with plastic. The plastic in the flexible composite layer 120 enables the flexible composite layer 120 to have insulating properties, and enables the flexible composite layer 120 to become an insulating layer having magnetizability or an insulating layer having magnetic properties. The magnetizable material, for example, includes manganese zinc (Mn—Zn) steel powders or other suitable magnetizable material. The magnetic material, for example, includes barium, strontium, rubidium, cobalt, boron, or iron oxide powders or other suitable magnetic material. The plastic, for example, is an engineering plastic having heat resistance, aging resistance and wear resistance. However, the invention is not limited thereto. Moreover, with the flexible properties of the flexible composite layer 120, processing thereto during the fabrication thereof is more convenient.

A magnetic attraction force can be generated between the flexible composite layer 120 and an object 60, so that the object 60 is attached on the flexible capacitive touch film 110, thereby enables users to use the touch device 100 more flexibly such as attaching paper by a magnet (object 60) on the touch device 100. Since the touch device 100 uses the flexible composite layer 120, which has the insulating properties, to generate the magnetic attraction force instead of using a metal layer to generate the magnetic attraction force, touch operations of the touch device 100 can be prevented from being interfered by the conductivity of the metal layer, and thus the touch device 100 could attract the object 60 with the magnetic attraction force under a condition of not interfering with the touch operations of the touch device 100.

In one embodiment, if the flexible composite layer 120, which is made from the magnetizable material mixed with plastic, has the magnetizability, the object 60 could be a magnetic element (e.g., a magnet), so that the magnetic attraction force could be generated between the flexible composite layer 120 and the object 60. In another embodiment, if the flexible composite layer 120, which is made from the magnetic material mixed with plastic, has the magnetic properties, the object 60 could be a magnetizable element (e.g., a metal piece) or a magnetic element (e.g., a magnet), so that the magnetic attraction force could be generated between the flexible composite layer 120 and the object 60.

In the embodiment, a material of the fixing surface 50 may include a magnetizable material (e.g., a metal piece). As such, a magnetic attraction force can be generated between the flexible composite layer 120 having the magnetic properties and the fixing surface 50 having the magnetizability. Therefore, the touch device 100 can be attached on the fixing surface 50, such as attaching the flexible composite layer 120 having the magnetic properties on a electronic whiteboard (not shown) so as to enable the electronic whiteboard to simultaneously have touch and magnetic functions. As a result, the touch device 100 could be installed without requiring the use of structures, such as a frame, a backboard, a hooks, etc., which could simplify the installation of the touch device 100, save the installation cost of the touch device 100, and/or reduce the volume and the weight of the touch device 100 for transportation. In other embodiment, a double-sided adhesive (not shown), which may adhere repeatedly (i.e. repositionable), could be used to replace the flexible composite layer 120, such that the touch device 110 could be installed on the fixing surface through using the double-sided adhesive by adhering a side of the double-sided adhesive at the back surface 110a of the flexible capacitive touch film 110 and adhering another side of the double-sided adhesive at the fixing surface. In another embodiment, a double-sided adhesive (not shown) which may adhere repeatedly (i.e. repositionable) can be disposed at the flexible composite layer 120, such that the touch device 100 could be installed on the fixing surface through using the double-sided adhesive by adhering a side of the double-sided adhesive at the flexible composite layer 120 and adhering another side of the double-sided adhesive at the fixing surface 50.

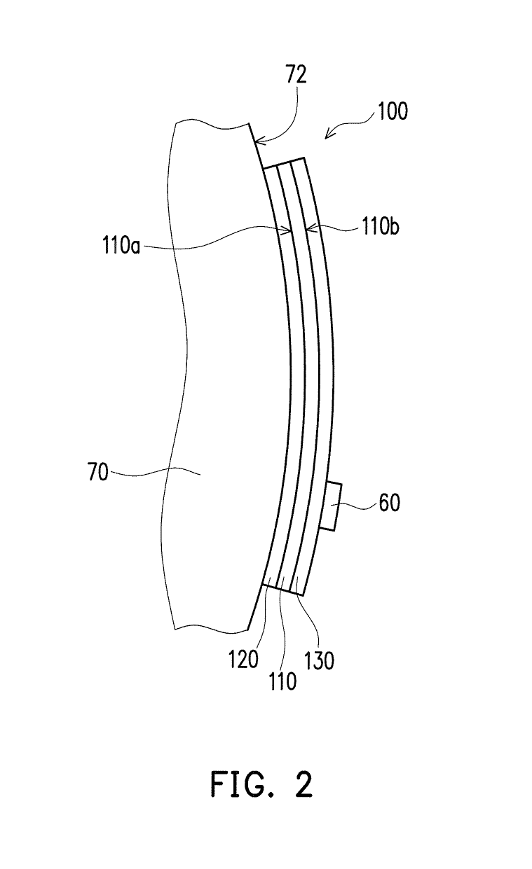

FIG. 2 illustrates the touch device of FIG. 1 being installed at a curve surface. Unlike being installed at a fixing end 50 having a flat surface 52 in the embodiment as exemplarily shown in FIG. 1, the touch device 100 in this embodiment may be installed at a fixing surface 70 having a curve surface 72 with the flexibilities of the flexible composite layer 120 and the flexible capacitive touch film 110 as exemplarily shown in FIG. 2, or be installed at a surface of other shape. Moreover, with the flexibilities of the flexible composite layer 120 and the flexible capacitive touch film 110, the touch device 100 of the embodiment can be rolled up and thus is easy for transportation and/or storage.

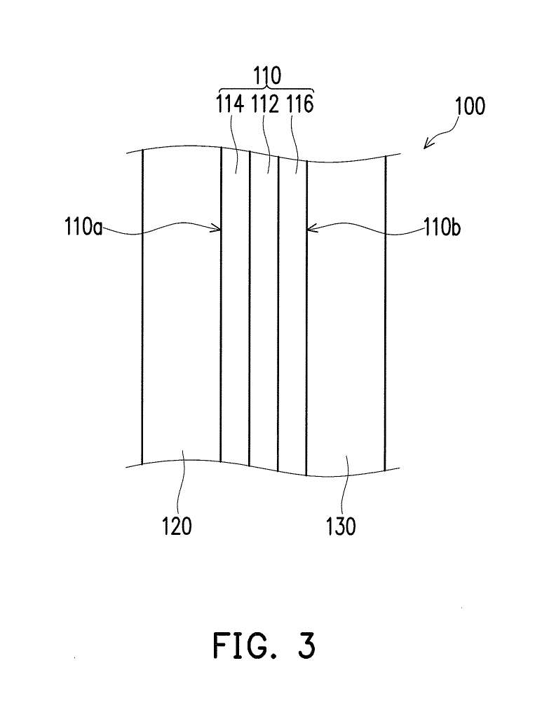

FIG. 3 is a partial enlarged view of the touch device of FIG. 1. Referring to FIG. 3, the flexible capacitive touch film 110 of the embodiment, for example, includes an insulating layer 112, a first touch-sensing layer 114 and a second touch-sensing layer 116. The first touch-sensing layer 114 and the second touch-sensing layer 116, for example, are respectively indium tin oxide (ITO) electrodes of a X axial direction and a Y axial direction, and are respectively disposed at two opposite sides of the insulating layer 112. In other embodiment, sensing lines of the first touch-sensing layer 114 and the second touch-sensing layer 116 of the flexible capacitive touch film 110 may respectively be made of metal lines (e.g., sliver material), and could be woven into a mesh. In other embodiment, the flexible composite layer may replace the insulating layer 112 so as to simplify the structure of the touch device. Further explanations, accompanied by a drawing, will be illustrated below.

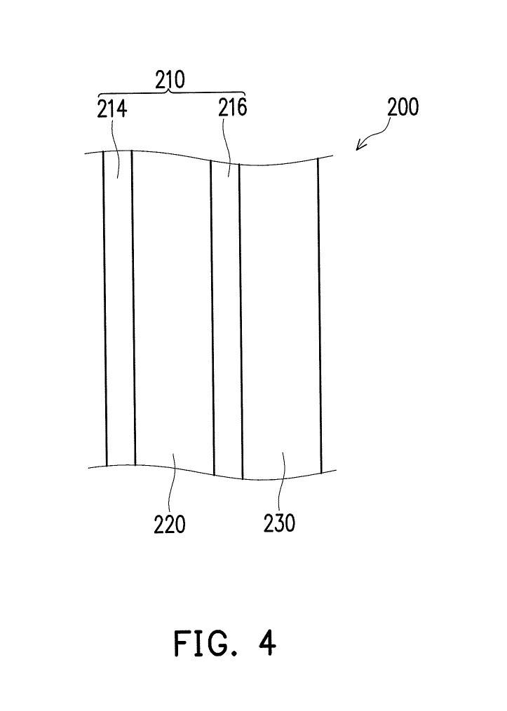

FIG. 4 is a partial enlarged view of a touch device according to another embodiment of the invention. In the touch device 200 of FIG. 4, functions of a first touch-sensing layer 214, a second touch-sensing layer 216, a flexible composite layer 220, and a reflective layer 230 of a flexible capacitive touch film 210 are similar to those of the first touch-sensing layer 114, the second touch-sensing layer 116, the flexible composite layer 120, and the reflective layer 130 of the flexible capacitive touch film 110 of FIG. 3, and thus will not be repeated. The flexible composite layer 220 is disposed between the first touch-sensing layer 214 and the reflective layer 230. A difference between the touch device 200 and the touch device 100 is that, the flexible composite layer 220 is disposed between the first touch-sensing layer 214 and the second touch-sensing layer 216, and thus replaces the insulating layer 112 shown in FIG. 3. As such, the thickness of the touch device 200 could be reduced, and is much easier for transportation and/or storage.

The embodiments of the invention may have one of the following benefits. In the embodiments of the invention, the flexible composite layer is disposed at the flexible capacitive touch film of the touch device. The material of the flexible composite layer is the magnetizable material mixed with plastic or the magnetic material mixed with plastic, so that the object can be attracted on the flexible capacitive touch film with the magnetic attraction force between the flexible composite layer having the electric insulating properties and the object, enabling users to use the touch device more flexibly. Since the touch device in the embodiments of the invention uses the flexible composite layer to generate the magnetic attraction force instead of using the metal layer to generate the magnetic attraction force, the touch operations of the touch device are prevented from being interfered by the conductivity of the metal layer used in the conventional device, and thus the touch device could attract the object with the magnetic attraction force under a condition of not interfering with the touch operations of the touch device. The touch device, in addition to being installed at a flat surface, may be installed at a curve surface with the flexibilities of the flexible composite layer and the flexible capacitive touch film, or be installed at a surface of other shape. The touch device may be attached on a fixing surface having a flat surface or a curve surface with the magnetic attraction force generated between the flexible composite layer having the magnetic properties and the fixing surface having the magnetizability, so that the installation of the touch device could be simplified. With the flexibilities of the flexible composite layer and the flexible capacitive touch film, the touch device can be rolled up and thus is easy for transportation and/or storage.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch device, comprising:
a flexible capacitive touch film; and
a flexible composite layer, disposed at the flexible capacitive touch film, wherein a material of the flexible composite layer comprises one of a magnetizable material and a magnetic material, and wherein the flexible composite layer is adapted to attract an object via a magnetic attraction force generated between the flexible composite layer and the object so that the object is capable of being attached on the flexible capacitive touch film.

2. The touch device of claim 1, wherein the material of the flexible composite layer comprises the magnetizable material and plastic.

3. The touch device of claim 1, wherein the flexible composite layer comprises the magnetic material and plastic.

4. The touch device of claim 1, wherein the flexible composite layer is an insulating layer.

5. The touch device of claim 1, wherein the touch device is a touch projection screen and further comprises a reflective layer adapted to receive an image beam projected by a projection device and reflect the image beam, wherein the flexible capacitive touch film is disposed between the reflective layer and the flexible composite layer.

6. The touch device of claim 1, wherein the touch device is adapted to be disposed on a fixing surface, the flexible capacitive touch film has a back surface, the back surface faces towards the fixing surface, and the flexible composite layer is disposed at the back surface.

7. The touch device of claim 1, wherein the flexible capacitive touch film comprises a first touch-sensing layer and a second touch-sensing layer, and the flexible composite layer is disposed between the first touch-sensing layer and the second touch-sensing layer.

8. The touch device of claim 3, wherein the touch device is adapted to be disposed on a fixing surface via a magnetic attraction force generated between the flexible composite layer and the fixing surface, and wherein a material of a fixing surface comprises a magnetizable material.

9. The touch device of claim 7, wherein the touch device is a touch projection screen and further comprises a reflective layer adapted to receive an image beam projected by a projection device and reflect the image beam, wherein the flexible composite layer is disposed between the first touch-sensing layer and the reflective layer.
